(19) United States
(12) Patent Application Publication
(10) Pub. No.: US 2004/0164989 A1
(43) Pub. Date: Aug. 26, 2004

(54) Method and apparatus for disclosing information, and medium for recording information disclosure program

(75) Inventors: Yoshinori Utsunomiya, Kawasaki (JP); Masaru Shoji, Yokohama (JP); Akira Oya, Yokohama (JP); Yoshiichi Chiba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/749,377

(22) Filed: Jan. 2, 2004

(30) Foreign Application Priority Data
Sep. 27, 2002 (JP) 2002-282119

(51) Int. Cl. G06F 13/00

(52) U.S. Cl. 345/536

(57) ABSTRACT

By using an dictionary for non-disclosure which manages non-disclosure character strings and non-disclosure reasons, and a forced disclosing dictionary for managing forcedly the disclosed character strings and forcedly disclosing reasons, disclosing tags, disclosing reasons, non-disclosure tags, reasons for disclosing, forcedly disclosing tags, and forcedly disclosing reasons are embedded in a document, and a character string assigned with an disclosing tag is replaced with a meaningless character string.

This configuration makes it possible to perform operations even if information which should be hidden and information which should not be hidden are not known when a document to be made public is created, causing the burden of a user to be reduced. A user can know the reason why the information which is not made public has not been made public. Even when information which is generally not made public is made public, the user can know the reason.

### BACKGROUND OF THE INVENTION

(1) Field of the Invention

The present invention relates to technology for creating documents to be opened to the general public while some portions of the original document are hidden (replaced with so-called meaningless characters).

(2) Description of the Related Art

Documents created at government and municipal offices are made public in response to the demand from a nation's people. At that time, in a case where information, which should not be opened to the general public (for example, specific person names, corporation names, etc.) is contained in the documents, these pieces of information must be deleted.

Japanese Unexamined Patent Application Publication No. 2002-207725 discloses an invention of a process (masking process) of masking portions to be deleted by filling in with black is performed on a file in the PDF (Portable Document Format) format. In a file in the PDF format, a layer specifically used to hide character information is defined, and by using this specifically used layer, a masking process is performed, making it possible to hide character information in a pseudo-manner.

However, since this is only a pseudo-hiding process, there is a problem in that information to be hidden still exists in the file. Accordingly, in Japanese Unexamined Patent Application Publication No. 2002-207725, the above-described problem is solved by automatically deleting character information corresponding to the portion on which a masking process is performed on the specifically used layer.

In the invention disclosed in Japanese Unexamined Patent Application Publication No. 2002-207725, when a user specifies a portion to be hidden, it is necessary to perform operations after information which should be hidden and information which should not be hidden are accurately known, and the burden on the user is large.

Furthermore, from the standpoint of the user, it is not possible to know the reasons why the information which is not made public has not been made public.

### SUMMARY OF THE INVENTION

An object of the present invention is to provide a method and apparatus for automatically processing and editing a document into content which is appropriate for disclosing when the document which should be opened to the public contains information which should be hidden.

In the present invention, by using a dictionary in which non-disclosure information for managing character strings which should not be made public and reasons for not being made public in such a manner as to correspond to each other is registered and a dictionary in which character strings which should be forcedly made public and reasons for being forcedly made public in such a manner as to correspond to each other is registered, an non-disclosure tag, reasons for not being made public, a forcedly disclosing tag, and reasons for being forcedly made public are embedded in the document, and a character string assigned with an non-disclosure tag is replaced with a meaningless character string.

### BRIEF DESCRIPTION THE DRAWINGS

FIG. 1 shows the system configuration of the present invention;

FIG. 2 shows the data structure of a dictionary which is not made public and an example of the content;

FIG. 3 shows the data structure of a dictionary which is forcedly made public and an example of the content;

FIG. 4 shows the data structure of a reason dictionary and an example of the content;

FIG. 5 shows a processing flow of a master document creation program;

FIG. 6 shows a processing flow of a forcedly disclosing program;

FIG. 7 shows a processing flow of a disclosing document creation program;

FIG. 8 shows an example of an original document;

FIG. 9 shows an example of a master document;

FIG. 10 shows an example of an intermediate document;

FIG. 11 shows an example of a disclosed document; and

FIG. 12 shows a list of tags.

### DETAILED DESCRIPTION OF THE INVENTION

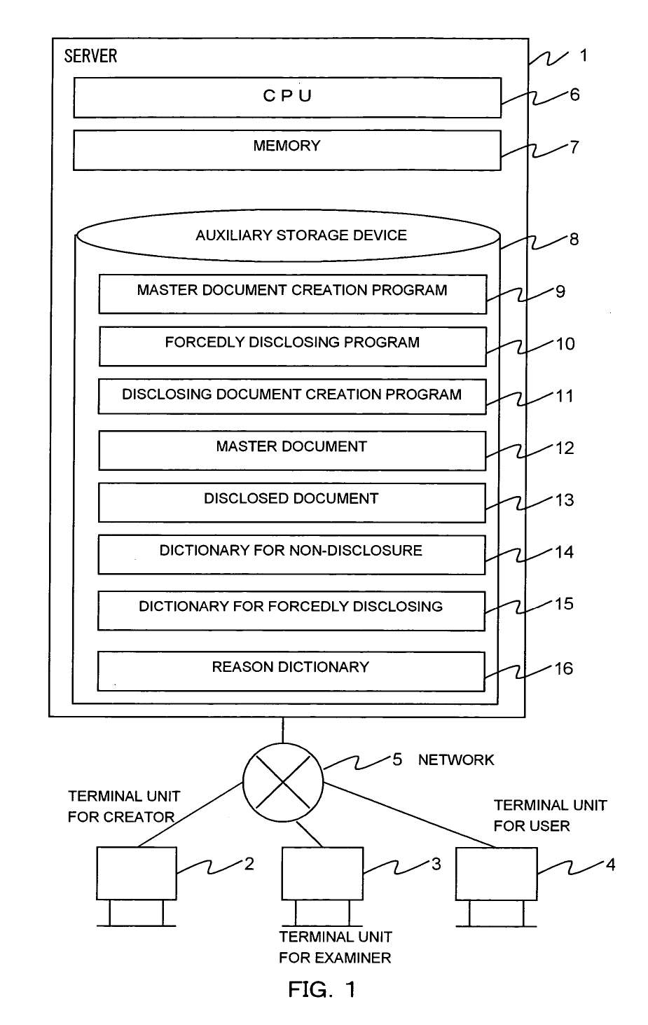

With reference to FIG. 1, the configuration of this embodiment will be described first. A server 1, a terminal unit 2 for a creator, a terminal unit 3 for an examiner, and a terminal unit 4 for a browser are connected to each other via a network 5. The server 1 is a computer having a CPU 6, a memory 7, and an auxiliary storage device 8. The terminal unit 2 for the creator, the terminal unit 3 for the examiner, and the terminal unit 4 for the user are each a computer having a CPU, a memory, a display, a keyboard, and a mouse.

In the server 1, a master document creation program 9 stored in the auxiliary storage device 8, a forcedly disclosing program 10, and a disclosing document creation program 11 are loaded into the memory 7, and is executed by the CPU 6. In the auxiliary storage device 8 of the server 1, furthermore, a master document 12, a disclosed document 13, a dictionary 14 for non-disclosure which character strings for non-disclosure are registered, a dictionary 15 for forcedly disclosing the non-disclosure character string, and a reason dictionary 16 for comments of non-disclosure are stored.

The document creator creates the master document 12 in the XML (Extensible Markup Language) format on the basis of the document created using a word processing program by executing the master document creation program 9. The master document 12 is assigned with a non-disclosure tag and reasons for non-disclosure with regard to a string of characters which should be hidden.

By executing the forcedly disclosing program 10 on the master document 12 created by the document creator, the examiner changes a string of characters which should be made public forcedly among the string of characters which are not made public within the master document 12, and creates a disclosed document 13 in the XML format by executing the disclosing document creation program 11 after the distinction between the string of characters which should be made public and the string of characters which should not be made public is confirmed. The users browse the disclosed document 13 by displaying it on the terminal unit 4 for the user.

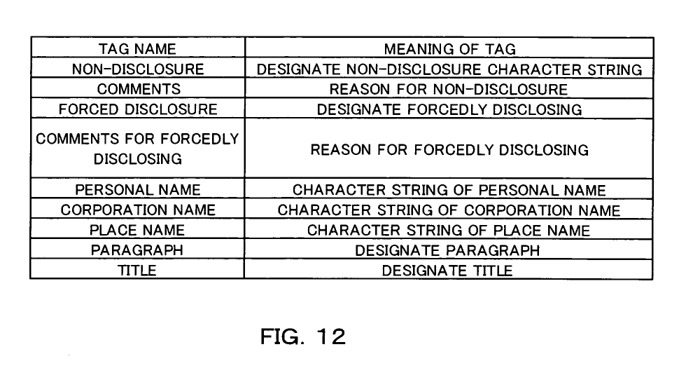

FIG. 12 shows a list table of tags used in this embodiment. The list table of tags is composed of a plurality of records made up of names of “tags” and items of “meanings of tags”. For example, “tags”, such as “non-disclosure”, “comments”, and “forced disclosure” designate “meanings of tags” of “a string of characters which should not be made public”, “reasons for not being made public”, and “a string of characters which are forcedly disclosed”, respectively.

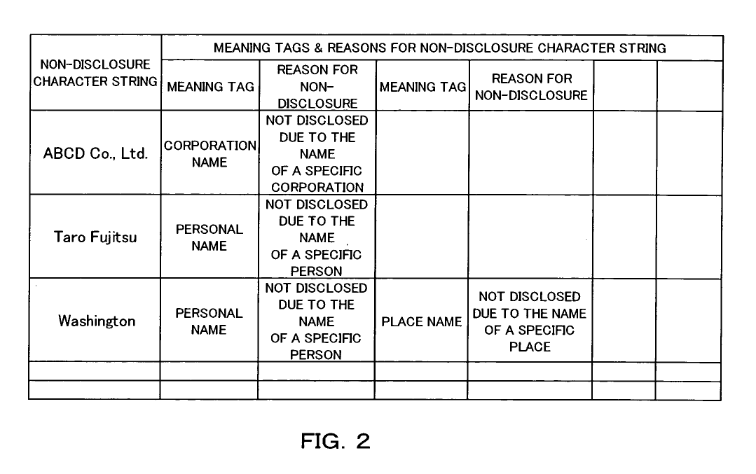

Referring to FIG. 2, the dictionary 14 for non-disclosure character string will now be described. The dictionary 14 for non-disclosure character string is a table made up of a plurality of records. Each record is composed of items of a string of characters which should not be made public, meaning tags which correspond to the string of characters, indicating the meaning indicated by the string of characters, and non-disclosure reasons for not being made public. For example, in the first record of the table, “ABCD Co., Ltd.” indicates a non-disclosure string of characters, and “name of a corporation” indicates the meaning tag, and “since ABCD Co., Ltd. is the name of a specific corporation” indicates the reason for non-disclosure. Furthermore, there are cases of having a plurality of meaning tags. For example, regarding “Washington”, the meaning tag is the name of a person, and the reason for not being made public is “since Washington is the name of a specific person, it is not made public”. Another meaning tag of Washington is “a place name”, and the reason for not being made public is “since Washington is the name of a specific place, it is not made public”.

The non-disclosure string of characters is used for matching with the string of characters in the document. The meaning tags and the non-disclosure reasons are embedded in the document.

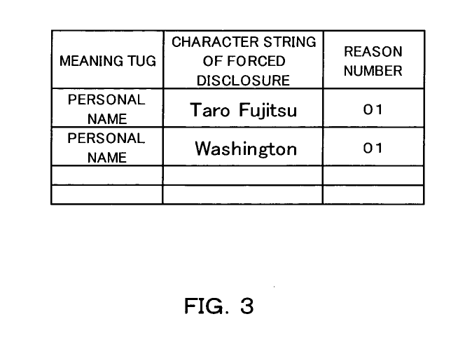

The dictionary 15 for forcedly disclosing will now be described with reference to FIG. 3. The dictionary 15 for forcedly disclosing is a table composed of a plurality of records. Each record is made up of a meaning tag, a forcedly disclosed character string, and a reason number. The meaning tag and the forcedly disclosed character string are used for matching with the strings of characters which are not made public in the document. The reason number is a pointer for one record of the reason dictionary 16 (to be described later).

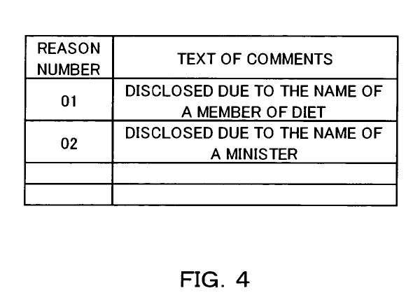

The reason dictionary 16 will now be described below with reference to FIG. 4. The reason dictionary 16 is a table composed of a plurality of records. Each record is made up of the reason number for not being made public, and the text of a comment for illustrating the reason for not being made public. The reason number is a value which is referred to by a certain record in the above-mentioned dictionary 15 for forcedly disclosing. The comment text is a string of characters embedded in the document.

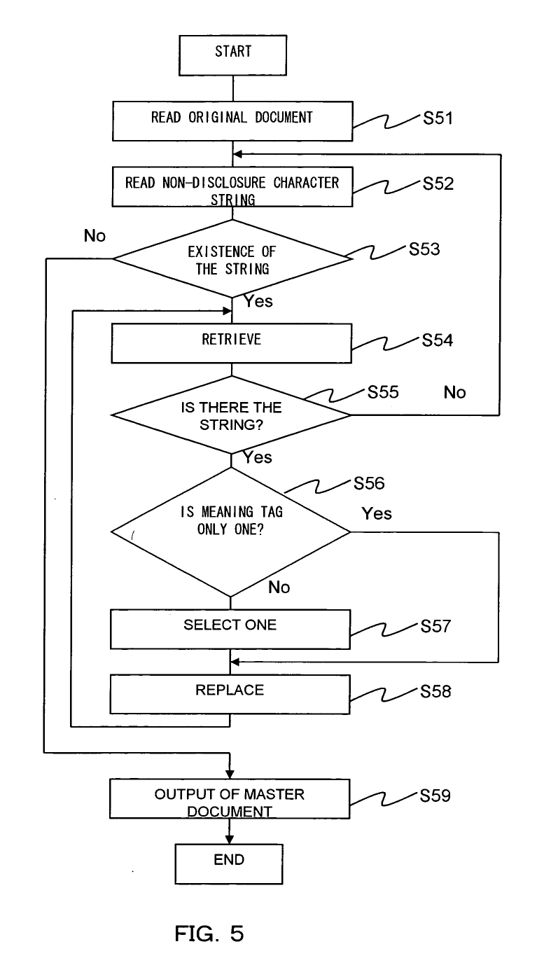

The master document creation program 12 will now be described below with reference to FIG. 5. In the master document creation program 12, first, the original document is read (step S51). Next, one character string which is not made public is read from the dictionary 14 for non-disclosure character string (step S52).

In step S53, if the non-disclosure character string cannot be read, the process proceeds to step S59. When the non-disclosure character string can be read, a search is made for a non-disclosure character string which is read from the beginning of the document (step S54).

In step S55, if there is a non-disclosure character string as a result of the search, the process proceeds to step S56. In the dictionary 14 for non-disclosure, if there are a plurality of meaning tags which are registered so as to correspond to the non-disclosure character string, a plurality of meaning tags are displayed, so that one meaning tag among them is selected by the user (step S57).

The meaning tag which is registered uniquely in the dictionary 14 for non-disclosure or the meaning tag selected by the user, and the non-disclosure reason corresponding to the meaning tag are used to replace the found character sequence (step S58). Processes from the searching of the non-disclosure character string up to the replacement of the character string are repeated until the end of the document is reached.

When the non-disclosure character string cannot be found, the next non-disclosure character string is read from the dictionary, and the process of replacing the character string in the document is repeated. Finally, the document is output as a master document 12 (step S59).

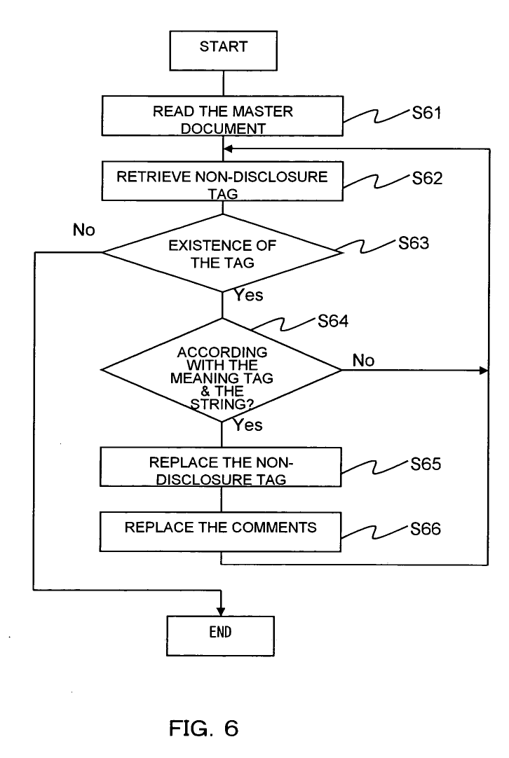

A process of a forcedly disclosing program 15 will now be described with reference to FIG. 6. First, the master document 12 is read (step S61). Next, a search for a non-disclosure tag is made in the document (step S62). In step S63, when the non-disclosure tag can be found, the meaning tag in the document, the meaning tag which matches the non-disclosure character string, and the forcedly disclosed character string are searched for in the forced disclosure dictionary 15 (step S64). When they cannot be found, this non-disclosure character string is not an object for forced disclosure. When they can be found, a non-disclosure releasing process is performed. More specifically, the non-disclosure tag is replaced with a forcedly disclosed tag (step S65), and the comment is replaced with a forced disclosure comment (step S66).

The above processes are repeated until the searching of the non-disclosure tag reaches the end of the document. When the processing is completed, the document is stored, as an intermediate document which is in an intermediate state, in the memory.

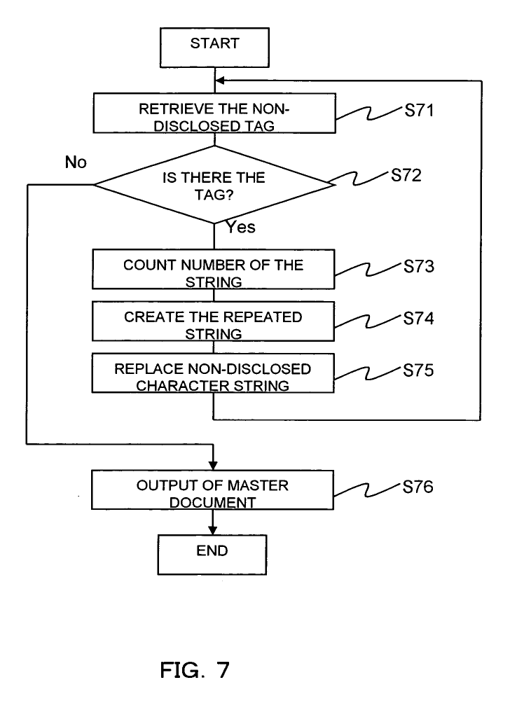

A process of the program 11 for creating a document to be made public will now be described with reference to FIG. 7. First, a non-disclosure tag is- searched for in the intermediate document stored in the memory (step S71). Next, when it is determined in step S72 that the non-disclosure tag cannot be found, the process proceeds to step S76. When the non-disclosure tag can be found, the number of characters of the non-disclosure character string is counted (step S73).

Next, a string of repetitive characters composed of “*”, the number of which is the same as the number of characters, is created (step S74), and the non-disclosure character string is replaced with this repetition character string (step S75) Here, although an example is used in which the character string is replaced with a string of meaningless characters for the number of characters to be hidden, the present invention is not limited to this example. Of course, it is effective to hide a string of characters with a larger number of characters. The above processes are repeated until the non-disclosure tag cannot be found, and finally, the document is output as a disclosed document 13.

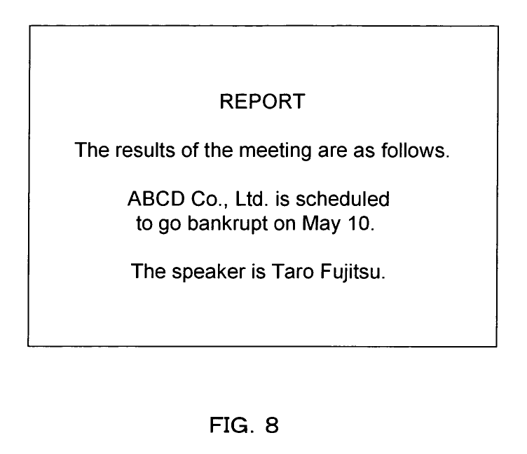

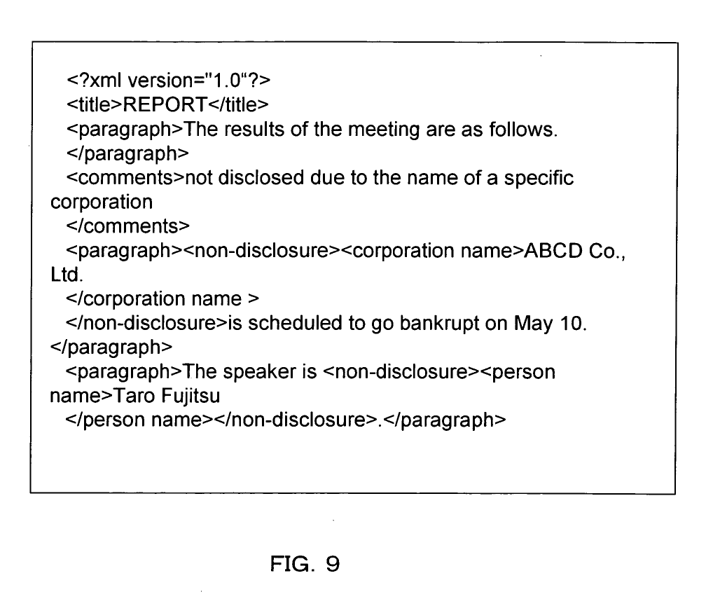

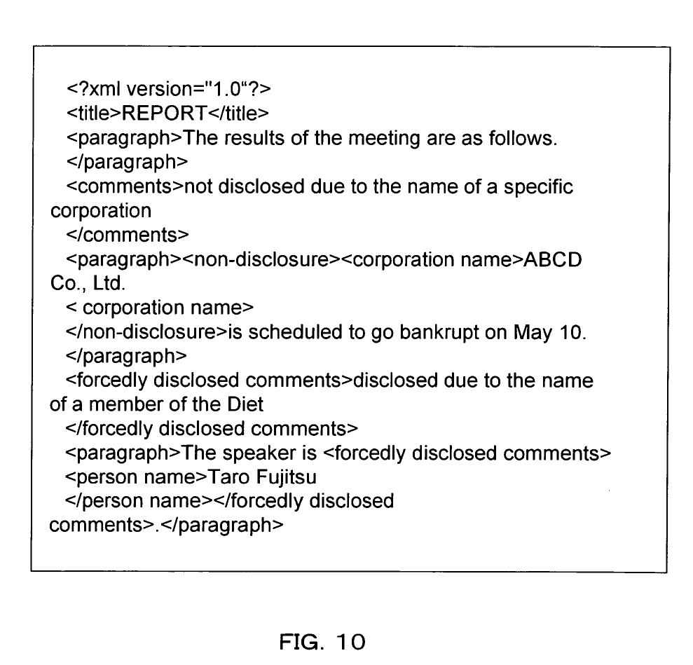

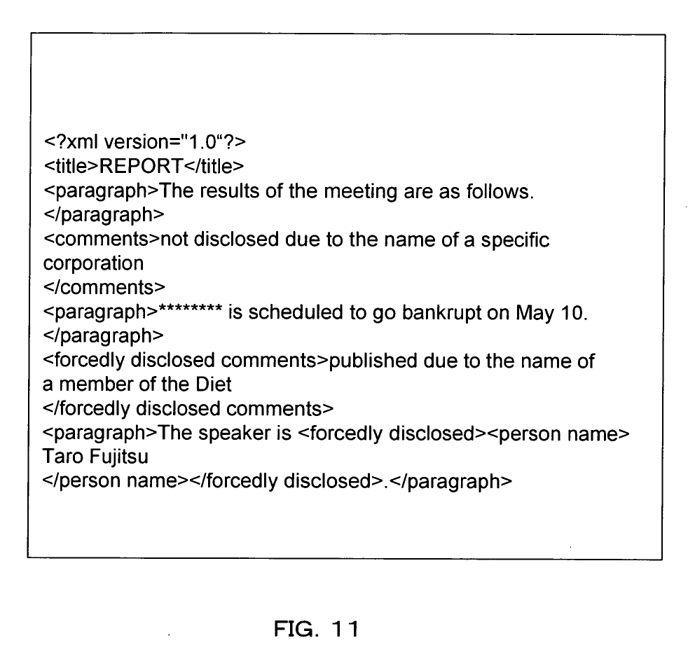

Referring to FIGS. 8, 9, 10, and 11, an example of the change of a document will be described below. FIG. 8 shows an example of the original document. In the master document creation program 9, by using the original document shown in FIG. 8 as an input, a master document 12 shown in FIG. 9 is output. By using this master document 12 as an input, in the forcedly disclosing program 10, an intermediate document shown in FIG. 10 is created. Next, in the disclosing document creation program 11, a disclosed document 13 shown in FIG. 11 is output.

Furthermore, the foregoing description is supplemented by a specific example.

FIG. 8 shows an example of the original document, where it is described that “The results of the meeting are as follows. ABCD Co., Ltd. is scheduled to go bankrupt on May 10. The speaker is Taro Fujitsu”.

In this original document, when the presence of the non-disclosure character string registered in the dictionary 14 for non-disclosure is searched for and the objective character string exists, a master document 12 in the XML format in which the non-disclosure character string and the reason for not being made public are inserted is created.

FIG. 9 shows a creation example of the master document 12, which is described in the XML format in the following manner.

<?xml version=“1.0”?>
<title>REPORT</title>
<paragraph>The results of the meeting are as follows.

</paragraph>

<comments>not disclosed due to the name of a specific

corporation</comments>

<paragraph><non-disclosure>
<corporation name>ABCD Co., Ltd.</corporation name >
</non-disclosure>is scheduled to go bankrupt on May 10.

</paragraph>

<paragraph>The speaker is <non-disclosure><person name>Taro

Fujitsu

</person name></non-disclosure>.</paragraph>

As described above, the following are shown: the reason for not being made public as “not disclosed because of the name of a specific corporation” using the <comments> tag, the fact that the string of characters of “ABCD Co., Ltd.” is not disclosed using the <non-disclosure> <corporation name> tag, and the fact that “Taro Fujitsu” is not disclosed using <non-disclosure> <person name> tag.

Next, in this master document 12, in a case where the presence of the forcedly disclosed character string corresponding to the non-disclosure tag registered in the forced disclosure dictionary 15 is searched for and the objective character string exists, an intermediate document is created in which the non-disclosure tag is inserted by being replaced with the forcedly disclosed character string and the reason for forcedly disclosing.

FIG. 10 shows an example of an intermediate document, which is described as follows.

<?xml version=“1.0”?>
<title>REPORT</title>
<paragraph>The results of the meeting are as follows.

</paragraph>

<comments>not disclosed due to the name of a specific

corporation</comments>

<paragraph><non-disclosure><corporation name>ABCD Co., Ltd.

< corporation name>

</non-disclosure>is scheduled to go bankrupt on May 10.

</paragraph>

<forcedly disclosed comments>disclosed due to the name of a

member of the Diet

</forcedly disclosed comments>
<paragraph>The speaker is <forcedly disclosed

comments><person name>Taro Fujitsu

</person name></forcedly disclosed comments>.</paragraph>

As described above, the reason for being forcedly disclosed as “disclosed due to the name of a member of the Diet” using the <forcedly disclosed comments> tag, and the fact that “Taro Fujitsu” is forcedly made public using the <forcedly disclosed> <person name> tag are shown.

In addition, an output example of the disclosed document 13 in which the final non-disclosure information and forcedly disclosing information are incorporated is shown in FIG. 11 in the following manner.

<?xml version=“1.0”?>
<title>REPORT</title>
<paragraph>The results of the meeting are as follows.

</paragraph>

<comments>not disclosed due to the name of a specific

corporation </comments>

<paragraph>******** is scheduled to go bankrupt on May 10.

</paragraph>

<forcedly disclosed comments>disclosed due to the name of a

member of the Diet

</forcedly disclosed comments>
<paragraph>The speaker is <forcedly disclosed><person

name>Taro Fujitsu

</person name></forcedly disclosed>.</paragraph>

In the manner described above, the non-disclosure portions are replaced with a meaningless character string like “********”, and the reason for being forcedly made public as “disclosed because of the name of a member of the Diet” using a <forcedly disclosed comments> tag, and the fact that “Taro Fujitsu” is forcedly disclosed using a <forcedly disclosed> <person name> tag are shown.

In the description up to this point, an embodiment has been described in which the server 1, the terminal unit 2 for the creator, the terminal unit 3 for the examiner, and the terminal unit 4 for the user are connected to each other via the network 5; however these units may be realized by a single computer.

What is claimed is:

1. A computer-readable recording medium recorded with an information disclosure program for disclosing selected parts of a document to be made public, the program comprising the steps of:
locating at least one character string of non-disclosure in the document by referring to an auxiliary storage unit storing a dictionary which contains said at least one character string of non-disclosure in association with at least one corresponding reason;
embedding a tag and the reason of non-disclosure corresponding to the character string in the document; and
replacing the character string to which the tag of non-disclosure is given to a meaningless character string, when the document is accessed.

2. A computer-readable recording medium recorded with an information disclosure program according to claim 1 wherein said dictionary further contains at least one character string of compulsory disclosure associated with at least one corresponding reason, the program further comprising the steps of:
locating the tag of non-disclosure in the document and determining if the character string corresponding to the tag of non-disclosure matches the character string of compulsory disclosure by referring to said dictionary; and
replacing the retrieved tag of non-disclosure with the tag for compulsory disclosure, and the retrieved reason of non-disclosure with the reason for compulsory disclosure, when the character string of non-disclosure corresponding to the retrieved tag is found in the said dictionary.

3. An information disclosure apparatus for disclosing selected parts of a document to be made public, comprising:
an auxiliary storage unit storing a dictionary which manages a character string of compulsory disclosure attaching with its corresponding reason;
a means for retrieving the character string of non-disclosure from an original document referring to the dictionary registered in the auxiliary storage unit;
a means for embedding the tag and the reason of non-disclosure corresponding to the character string in the document; and
a means for replacing the character string which the tag of non-disclosure is given to a meaningless character string.

4. An information disclosure apparatus according to claim 3 for compulsorily disclosing the said non-disclosing parts of the document to be made public, comprising:
an auxiliary storage unit as a dictionary which manages a character string of compulsory disclosure attaching with its corresponding reason;
a means for retrieving the said tag for non-disclosing in the document, while collating the said dictionary for the compulsory disclosure; and
a means for replacing the retrieved tag of non-disclosure with the tag for compulsory disclosure, and the retrieved reason of non-disclosure with the reason for compulsory disclosure, when the character string of non-disclosure corresponding to the retrieved tag is found in the said dictionary.

5. A method for disclosing selected parts of a document to be made public, comprising the steps of:
locating at least one character string of non-disclosure in the document by referring to an auxiliary storage unit storing a dictionary which contains said at least one character string of non-disclosure in association with at least one corresponding reason;
embedding a tag and the reason of non-disclosure corresponding to the character string in the document; and
replacing the character string to which the tag of non-disclosure is given to a meaningless character string, when the document is accessed.

6. A method according to claim 5 for compulsorily disclosing the said non-disclosing parts of the document, comprising the steps of:
locating the tag of non-disclosure in the document and determining if the character string corresponding to the tag of non-disclosure matches the character string of compulsory disclosure by referring to said dictionary; and
replacing the retrieved tag of non-disclosure with the tag for compulsory disclosure, and the retrieved reason of non-disclosure with the reason for compulsory disclosure, when the character string of non-disclosure corresponding to the retrieved tag is found in the said dictionary.
